(19) United States
(12) Patent Application Publication
(10) Pub. No.: US 2026/0045878 A1
(43) Pub. Date: Feb. 12, 2026

(54) MULTI-PHASE BUCK-BOOST CHARGER ARCHITECTURE

(71) Applicant: Apple Inc., Cupertino, CA (US)

(72) Inventors: Wendy Ng, Los Gatos, CA (US); Peter Hazucha, Cupertino, CA (US); John P Bazinet, Fremont, CA (US); Shimon Elkayam, San Jose, CA (US); Shangyang Xiao, Millbrae, CA (US); Bin Gu, Sunnyvale, CA (US); Rui Chen, Sunnyvale, CA (US)

(21) Appl. No.: 18/796,844

(22) Filed: Aug. 7, 2024

(51) Int. Cl. H02M 3/158; H02J 7/00

(52) U.S. Cl. CPC H02M 3/1582; H02J 7/007; H02J 2207/20

(57) ABSTRACT

A multi-phase buck-boost converter system can include an external discrete component power stage and a controller integrated circuit. The external discrete component power stage can include a first and second phases each respectively having an input half bridge including first and second or third and fourth discrete switching devices and corresponding first and second discrete inductors operable as first and second buck stages. The controller integrated circuit can include a first and second output half bridges respectively corresponding to the first and phases and respectively having fifth and sixth or seventh and eighth integrated switching devices respectively coupled to the first or second discrete inductors and respectively operable as first and second boost stages in conjunction with the first and second buck stages as a first buck-boost converter and controller circuitry that operates the first and second buck-boost converters to produce a regulated output voltage from an input voltage.

### BACKGROUND

In some applications, single phase buck-boost chargers may be used for battery charging in electronic devices, such as those incorporating batteries in a series configuration. As one example, a lithium ion (Li-ion) cell may have a nominal voltage of about 3.7V. In some applications, multiple such cells may be connected in series and/or in parallel to form a battery pack. For example, a “3S” configuration can include three such cells (or groups of two or more parallel cells) in series to produce a nominal output voltage of about 11.1V. As noted above, a buck-boost charger can be used with such cells to allow for the battery to be charged from a variety of supplied input voltages that can be either lower or higher than the nominal output voltage, while producing an output voltage suitable to meet a selected charging profile for the battery. However, present and anticipated future electronic devices may present operating constraints that pose challenges to employing a conventional buck-boost charger architecture.

### SUMMARY

Thus, it may be desirable to provide an improved charger architecture. As described in greater detail herein, the improved charger architecture may include multiple phases (e.g., two phases) and may have certain switching devices integrated into an integrated circuit control circuitry for such charger while having other switching devices external to the integrated circuit to allow for selection of optimal switching devices for the high voltage/input side and low voltage/output side of the charger.

A multi-phase buck-boost converter system can include an external discrete component power stage and a controller integrated circuit. The external discrete component power stage can include a first phase having an input half bridge including first and second discrete switching devices and a corresponding first discrete inductor operable as a first buck stage; and a second phase having an input half bridge including third and fourth discrete switching devices and a corresponding second discrete inductor operable as a second buck stage. The controller integrated circuit can include a first output half bridge corresponding to the first phase and having fifth and sixth integrated switching devices coupled to the first discrete inductor and operable as a first boost stage in conjunction with the first buck stage as a first buck-boost converter; a second output half bridge corresponding to the second phase and having seventh and eighth integrated switching devices coupled to the second discrete inductor and operable as a second boost stage in conjunction with the second buck stage as a second buck-boost converter; and controller circuitry that operates the first and second buck-boost converters to produce a regulated output voltage from an input voltage.

The first and second phases and first and second output half bridges can be operable for high load operation, and only one of the first phase and first output half bridge or second phase and second output half bridge can be operable for low load operation. The regulated output voltage can be used for battery charging, and the controller integrated circuit can further include controller circuitry that controls a charging voltage delivered to a battery. The controller integrated circuit can include one or more sensing inputs including an input voltage sensing input, an input current sensing input, an output voltage sensing input, and a battery current sensing input. The fifth, sixth, seventh, and eighth switching devices can be integrated on a single integrated circuit die with the controller circuitry that operates the first and second buck-boost converters to produce the regulated output voltage from the input voltage. The first, second, third, and fourth discrete switching devices can be GaN switching devices. The controller circuitry can operate the first and second buck-boost converters at the same switching frequency and 180 degrees out of phase. The first, second, third, fourth, fifth, sixth, seventh, and eighth switching devices can be MOSFET devices.

A controller integrated circuit for a multi-phase buck-boost converter system can include a first output half bridge corresponding to a first phase of the multi-phase buck-boost converter system and having first and second integrated switching devices couplable to a first external inductor and operable as a first boost stage in conjunction with a first external discrete component buck stage as a first buck-boost converter; a second output half bridge corresponding to a second phase of the multi-phase buck-boost converter system and having third and fourth integrated switching devices couplable to a second external inductor and operable as a second boost stage in conjunction with a second external discrete component buck stage as a second buck-boost converter; and controller circuitry that operates the first and second buck-boost converters to produce a regulated output voltage from an input voltage.

The first and second phases and first and second output half bridges can be operable for high load operation, and only one of the first phase and first output half bridge or second phase and second output half bridge can be operable for low load operation. The regulated output voltage can be used for battery charging, and the controller integrated circuit can further include controller circuitry that controls a charging voltage delivered to a battery. The controller integrated circuit can include one or more sensing inputs including an input voltage sensing input, an input current sensing input, an output voltage sensing input, and a battery current sensing input. The first, second, third, and fourth switching devices can be integrated on a single integrated circuit die with the controller circuitry that operates the first and second buck-boost converters to produce the regulated output voltage from the input voltage. The controller integrated circuit can include a plurality of drive outputs each corresponding to an external discrete switching device of the first or second external buck stages. The controller integrated circuit can include first and second power inputs respectively couplable to the first and second external inductors that connect the first and second external inductors to respective switch nodes of the first and second output half bridges. The controller circuitry can operate the first and second buck-boost converters at the same switching frequency and 180 degrees out of phase.

An electronic device can include one or more electronic systems selected from the group consisting of a processor, a memory, storage, a display, an input device, an I/O interface, and a network interface; and a power system including a multi-phase buck-boost converter system that includes an external discrete component power stage and a controller integrated circuit. The external discrete component power stage can include a first phase having an input half bridge including first and second discrete switching devices and a corresponding inductor operable as a first buck stage; and a second phase having an input half bridge including third and fourth discrete switching devices and a corresponding inductor operable as a second buck stage. The controller integrated circuit can include a first output half bridge corresponding to the first phase and having fifth and sixth integrated switching devices coupled to the first inductor and operable as a first boost stage in conjunction with the first buck stage as a first buck-boost converter; a second output half bridge corresponding to the second phase and having seventh and eighth integrated switching devices coupled to the second inductor and operable as a second boost stage in conjunction with the second buck stage as a second buck-boost converter; and controller circuitry that operates the first and second buck-boost converters to produce a regulated output voltage from an input voltage, wherein the regulated output voltage can be used to power the one or more electronic systems.

The first and second phases and first and second output half bridges can be operable for high load operation, and only one of the first phase and first output half bridge or second phase and second output half bridge can be operable for low load operation. The power system can include a battery; the regulated output voltage can be used for battery charging; and the controller integrated circuit can further include controller circuitry that controls a charging voltage delivered to a battery. The fifth, sixth, seventh, and eighth switching devices can be integrated on a single integrated circuit die with the controller circuitry that operates the first and second buck-boost converters to produce the regulated output voltage from the input voltage. The first, second, third, and fourth discrete switching devices can be GaN switching devices. The controller circuitry can operate the first and second buck-boost converters at the same switching frequency and 180 degrees out of phase. The first, second, third, fourth, fifth, sixth, seventh, and eighth switching devices can be MOSFET devices.

### BRIEF DESCRIPTION OF THE DRAWINGS

FIG. 1 illustrates a block diagram of an electronic device.

FIG. 2 illustrates a simplified schematic of a single-phase buck-boost charger system.

FIG. 3 illustrates a simplified schematic of a dual phase buck-boost charger system.

FIG. 4 illustrates a graph of efficiency versus load for a single-phase buck-boost charger system, a dual phase buck-boost charger system with discrete switching devices, and a dual phase buck-boost charger system with some switching devices integrated.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

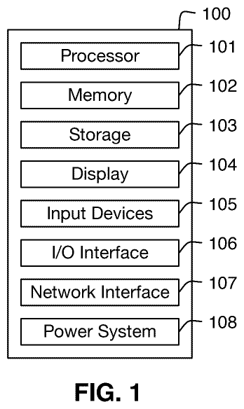

FIG. 1 is a block diagram of an electronic device 100, according to embodiments of the present disclosure. The electronic device 100 may include, among other things, one or more processors 101 (collectively referred to herein as a single processor for convenience, which may be implemented in any suitable form of processing circuitry), memory 102, nonvolatile storage 103, a display 104, input devices 105, an input/output (I/O) interface 106, a network interface 107, and a power system 108. The various functional blocks shown in FIG. 1 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 1 is merely one example of a particular implementation and is intended to illustrate the types of components that may be present in the electronic device 100.

By way of example, the electronic device 100 may include any suitable computing device, including a desktop or laptop/notebook computer (such as a MacBook®, MacBook® Pro, MacBook Air®, iMac®, Mac® mini, or Mac Pro® available from Apple Inc. of Cupertino, California), a portable electronic or handheld electronic device such as a wireless electronic device or smartphone (such as an iPhone® available from Apple Inc. of Cupertino, California), a tablet computer (such as an iPad® available from Apple Inc. of Cupertino, California), a wearable electronic device (such as an Apple Watch® by Apple Inc. of Cupertino, California), and other similar devices.

Processor 101 and other related items in FIG. 1 may be embodied wholly hardware or by hardware programmed to execute suitable software instructions. Furthermore, the processor 101 and other related items in FIG. 1 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 1, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100 In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable electronic device 100 to interface with various other electronic devices, as may the network interface 107. In some embodiments, the I/O interface 106 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter, which may be external, etc. Power system 108 may include a battery and a dual phase buck-boost charger architecture as described in greater detail below.

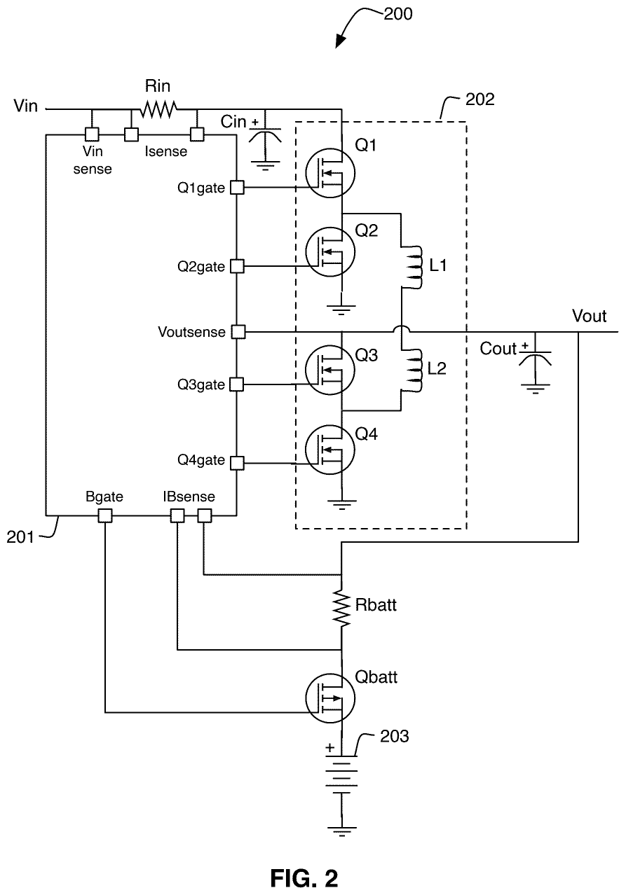

FIG. 2 illustrates a simplified schematic of a single-phase buck-boost charger system 200. As briefly mentioned above, single-phase buck-boost chargers for some application (e.g., 3S battery configurations) may run into limits when high-power levels (e.g., 140 W and above), lower component height (i.e., z-axis height), and reduced printed circuit board space (i.e., x-y area) are desired. As one, non-limiting charger application, the input voltage can be 28V, and the output voltage can be 13V nominal. For a single-phase buck-boost charger architecture, implemented with silicon FETs (field effect transistors) as switching devices used on input side as buck FETs, devices with a 40V break-down voltage rating may be employed. However, such devices can be large (bulky) and can have relatively high gate capacitance, limiting the switching frequency. As one example, switching frequency might be limited to around 600 kHz in some applications. Additionally, in such an implementation to safely process the input power, the inductor's physical height may exceed the enclosure limitations. For example with a 140 W load, peak inductor current may be about 14A. Thus, in an exemplary embodiment, two inductors may be connected in series to provide the desired electrical and magnetic properties, while limiting the physical height to fit within the portable electronic device enclosure limitations at the expense of larger surface area. With the decoupling capacitors at charger sized to handle the RMS current and output capacitors sized to meet output voltage ripple requirements, the charging circuit may reach a size that is unwieldy.

With reference to FIG. 2, the input voltage to the system can be Vin. This may be a nominal voltage of 28V, although other voltages could also be provided. For example, a USB-C/USB-PD charger could be provided, which could provide input voltages of 5V, 9V, 12V, 15V, 20V, etc. The charger system 200 can include an integrated circuit controller 201 and an external power stage 202, which provide the desired output voltage Vout. The output voltage Vout may be used to power system loads of an electronic device, such as electronic device 100 described above with reference to FIG. 1. The output voltage Vout may also be used to provide charging of a battery 203.

To accomplish battery charging, the output voltage Vout can be provided to the battery by a device Qbatt, controlled by the controller (via output terminal Bgate) to selectively deliver voltage/current to or from the battery for charging or discharging. The implementation illustrated in FIG. 2 is simplified in this respect, as there may be more complex circuitry that regulates the voltage and/or current delivered to battery 203 to correspond to a desired charging profile, as well as allowing battery 203 to power the output bus and thereby power the other system loads connected thereto. The charging circuitry can also sense the battery charging current, such as using a current sensing resistor Rbatt (coupled to inputs IBsense), although other current sensor arrangements (e.g., Hall effect sensors, etc.) could also be used.

Controller 201 can be implemented as an integrated circuit that cooperates with an external power stage to produce the regulated output voltage Vout from the input voltage Vin. In the illustrated example, the charger system includes a buck-boost converter. From a power stage perspective, the buck-boost converter includes an input half bridge made up of switches Q1 and Q2, a series inductor combination L1/L2, and an output half-bridge made up of switches Q3 and Q4. The input half bridge may also be considered to be the high voltage half bridge, in that it is exposed to the input voltage. The input half bridge may also be considered to be the buck half bridge, as it can cooperate with the inductor combination L1/L2 to produce a reduced voltage that is provided to the boost stage of the buck-boost converter. The output half bridge may also be considered to be the low voltage half bridge, as it is only exposed to the reduced voltage bucked from the input half bridge. The output half bridge may also be considered to be the boost half bridge, as it can cooperate with the inductor combination L1/L2 to produce an increased voltage can be provided to the output bus.

In the illustrated example, the inductor of the buck-boost converter is illustrated as a series inductor combination, which may be employed in some embodiments for reasons such as those described above. However, in some embodiments, the inductor could be implemented as a single inductor. Additionally, switching devices Q1-Q4 are illustrated as MOSFET (metal oxide semiconductor field effect transistor) devices, although other types of switching devices could also be used as appropriate for a given embodiment. Similarly, switching devices Q1-Q4 may be implemented using any suitable semiconductor technology, such as silicon (Si) devices, silicon carbide (SiC) devices, gallium nitride (GaN) devices, etc.

An additional function of controller 201 (beyond controlling delivery of charging voltage/current to battery 203) can be to provide gate drive signals for the switching devices Q1-Q4 to achieve the buck-boost operation described above. To that end, the controller can include internal circuitry (not shown) that can include any suitable combination of analog circuitry, digital circuitry, and/or programmable circuitry that monitors various inputs and generates the gate drive signals provided to switching devices Q1-Q4 to perform the required switching operations to generate the desired output voltage (and/or current). Thus, controller 201 may include output terminals Q1gate, Q2gate, Q3gate, and Q4 gate that provide the drive signals to the respective buck-boost switching devices described above. Controller 201 may also include additional input terminals Vinsense (for sensing input voltage), Isense (for sensing input current via current sense resistor Rin or other suitable sensor), Voutsense (for sensing output voltage), etc. The internal circuitry of integrated circuit controller 201 can implement any desired control functionality, including output voltage regulation, output current regulation (which may depend on additional input current sensing inputs, not shown), current limiting (cither input or output), input voltage regulation, thermal protection (via additional temperature sensing inputs, not shown), etc.

Additional components of the charger system 200 can include input bulk capacitance Cin and output bulk capacitance Cout. These are each illustrated as single capacitors, although in some embodiments they may include multiple capacitors connected in parallel to provide a desired capacitance. A variety of factors may affect the desired capacitance, such as a target ripple voltage, a target hold up time on loss of input power, control loop stability, a desired transient response capability, etc. Likewise, a variety of factors may affect the number of capacitors used, such as total capacitance required, available z-axis height, available circuit board area (xy-space), etc.

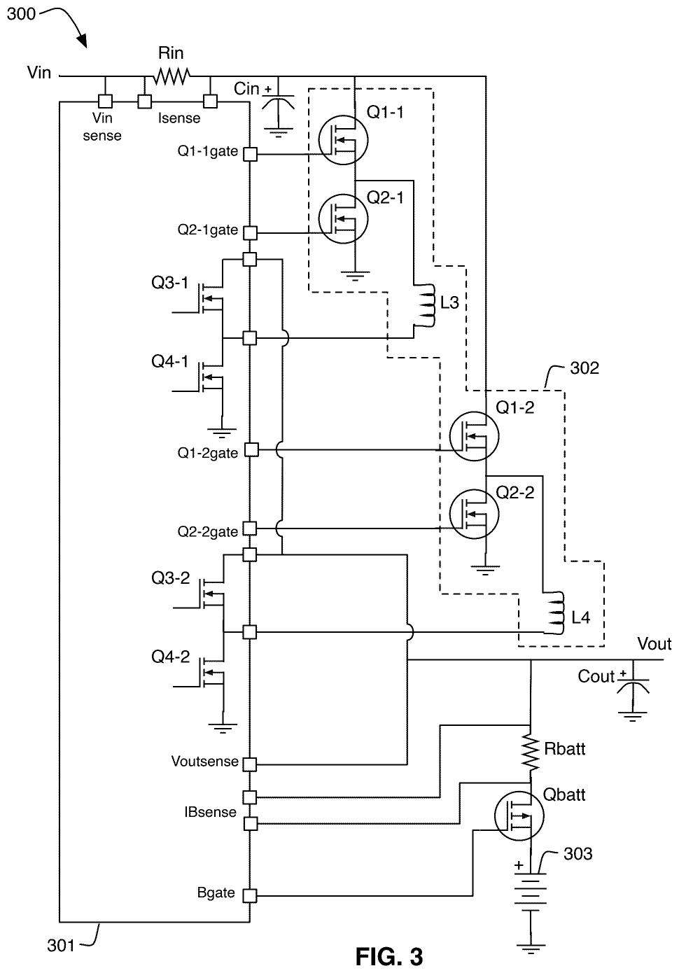

In certain applications, limitations of single-phase buck-boost charger architectures, including but not limited to those discussed above, may motivate an alternative charger design, such as a multi-phase buck-boost architecture as illustrated in FIG. 3. FIG. 3 illustrates a simplified schematic of a dual phase buck-boost charger system 300, although higher numbers of phases could also be implemented. The input voltage to the dual phase buck-boost charger system 300 can be Vin. This may be a nominal voltage of 28V, although other voltages could also be provided. For example, a USB-C/USB-PD charger could be provided, which could provide input voltages of 5V, 9V, 12V, 15V, 20V, etc. In some embodiments, multiple phases (e.g., two phases) can be used together when relatively higher levels of power are required (e.g., operation at 20V, 5A), while only a single phase can be used when lower power levels of power are required (e.g., 15V, 3A). The charger system 300 can include an integrated circuit controller 301 and an external power stage 302, which provide the desired output voltage Vout. The output voltage Vout may be used to power system loads of an electronic device, such as electronic device 100 described above with reference to FIG. 1. The output voltage Vout may also be used to provide charging of a battery 303.

To accomplish battery charging, the output voltage Vout can be provided to the battery by a device Qbatt, controlled by the controller (via output terminal Bgate) to selectively deliver voltage/current to or from the battery for charging or discharging. The implementation illustrated in FIG. 3 is simplified in this respect, as there may be more complex circuitry that regulates the voltage and/or current delivered to battery 303 to correspond to a desired charging profile, as well as allowing battery 303 to power the output bus and thereby power the other system loads connected thereto. The charging circuitry can also sense the battery charging current, such as using a current sensing resistor Rbatt (coupled to inputs IBsense), although other current sensor arrangements (e.g., Hall effect sensors, etc.) could also be used.

Controller 301 can be implemented as an integrated circuit that cooperates with an external power stage to produce the regulated output voltage Vout from the input voltage Vin. In the illustrated example, the charger system includes a dual phase buck-boost converter that is partially integrated with controller 301. From a power stage perspective, the buck-boost converter includes two input half bridges, a first input half bridge made up of switches Q1-1 and Q2-1 and a corresponding inductor L3, and a second input half bridge made up of switches Q1-2 and Q2-2 and a corresponding inductor LA. These input half bridges may also be considered to be high voltage half bridges, in that they are exposed to the input voltage. The input half bridges may also be considered to be buck half bridges, as they can cooperate with their respective inductors L3/L4 to produce a reduced voltage that is provided to the boost stages of the dual phase buck-boost converter.

The output half bridges of the respective converter phases may be integrated with the controller 301. That is, switching devices Q3-1 and Q4-1 (i.e., the first output half bridge) and switching devices Q3-2 and Q4-2 (i.e., the second output half bridge) may be formed on the same integrated circuit die as controller 301. In some embodiments, they may be formed on a separate integrated circuit die from some or all of the circuitry and components of controller 301 but contained within a common integrated circuit package. The respective output half bridges may also be considered to be low voltage half bridges, as they are only exposed to the reduced voltage bucked from the respective corresponding input half bridges. The output half bridges may also be considered to be the boost half bridges, as they can cooperate with the respective inductors L3/L4 to produce an increased voltage can be provided to the output bus. To that end, the respective inductors can be coupled to respective switch nodes of the output half bridges via terminals of the controller 301.

By implementing the buck-boost converter in a multi-phase configuration, the load current can be shared between the phases, allowing for individual inductors per phase (rather than series inductors per phase as discussed above with respect to FIG. 2) to be used to accommodate the same, or potentially even higher load currents. Moreover, because of the reduced current levels required, the two (or more) inductors (e.g., one per phase) may be smaller for the same total current handling capacity as compared to implementations such as those discussed above with respect to FIG. 2. Additionally, because conduction losses are proportional to the square of the current, splitting the current between two or more phases each carrying half (or less) of the current can result in substantial efficiency improvements for the same total current. In at least some embodiments, the respective buck-boost phases may be operated with their switching at the same frequency but 180 degrees out of phase (for two phases) to maximize this current sharing ability and correspondingly reduce the output ripple seen at the output and/or by any connected loads and to reduce the effective input ripple current seen by the input bulk capacitors, which reduces the required capacitance or number of capacitors required for a specific application.

Additionally, switching devices Q1-1-Q4-2 are illustrated as MOSFET (metal oxide semiconductor field effect transistor) devices, although other types of switching devices could also be used as appropriate for a given embodiment. Similarly, switching devices Q1-1-Q4-2 may be implemented using any suitable semiconductor technology, such as silicon (Si) devices, silicon carbide (SiC) devices, gallium nitride (GaN) devices, etc. In particular, because of the partial integration of the circuit, namely the integration of the boost phase switching devices into controller 301, semiconductor devices having optimized performance characteristics (based on their implementation) may be selected for each purpose. As but one example, integrating the boost phase switching devices Q3-1, Q4-1, Q3-2, and Q4-2 into the controller can allow for the use of silicon-based switching devices, and the integration can allow for reduced device footprint, reduced need for PCB trace routing, reduced parasitic effects, reduced switching losses, decreased cost, etc. Additionally, because the higher voltage buck switching devices of the input phases are separate components, they may be implemented using an alternative technology, e.g., GaN, that can allow for reduced size as compared to discrete silicon switches, increased switching frequency due to decreased gate capacitance, and other advantageous effects. Additionally, by integrating the boost phase switches, and increasing the switching frequency, the net effect on solution size can be reduced compared to the single phase, non-integrated solution described above with respect to FIG. 2. Moreover, for the same or greater power handling capability, the total number of external switches and inductors (i.e., the number of components in external power stage 302) can be equivalent to the number of components in external power stage 202.

A further function of controller 301 (beyond controlling delivery of charging voltage/current to battery 303) can be to provide gate drive signals for the switching devices Q1-1-Q4-2 to achieve the buck-boost operation described above. To that end, the controller can include internal circuitry (not shown) that can include any suitable combination of analog circuitry, digital circuitry, and/or programmable circuitry that monitors various inputs and generates therefrom gate drive signals provided to switching devices Q1-1-Q4-2 to perform the required switching operations to generate the desired output voltage (and/or current). Thus, controller 301 may include output terminals Q1-1gate, Q2-1gate, Q1-2gate, and Q2-2 gate that provide the drive signals to the respective buck switching devices described above. Because boost phase switching devices Q3-1, Q4-1, Q3-2, and Q4-2 are integrated with the controller circuitry, their drive signals may be internal connections and external terminals are not required. Controller 301 may also include additional input terminals Vinsense (for sensing input voltage), Isense (for sensing input current via current sense resistor Rin or other suitable sensor), Voutsense (for sensing output voltage), etc. The internal circuitry of integrated circuit controller 301 can implement any desired control functionality, including output voltage regulation, output current regulation (which may depend on additional input current sensing inputs, not shown), current limiting (either input or output), thermal protection (via additional temperature sensing inputs, not shown), etc.

Additional components of the charger system 300 can include input bulk capacitance Cin and output bulk capacitance Cout. These are each illustrated as single capacitors, although in some embodiments they may include multiple capacitors connected in parallel to provide a desired capacitance. A variety of factors may affect the desired capacitance, such as a target ripple voltage, a target hold up time on loss of input power, a desired transient response capability, etc. Likewise, a variety of factors may affect the number of capacitors used, such as total capacitance required, available z-axis height, available circuit board area (xy-space), etc.

Although described herein in terms of a dual phase buck-boost converter system, the principles described herein may be extended to include further numbers of phases, such as a three-phase, four-phase, or higher number of phases system. In such configurations, it may be desirable to alter the phase shift between the respective phases to be 360/n degrees apart, where n is the number of phases.

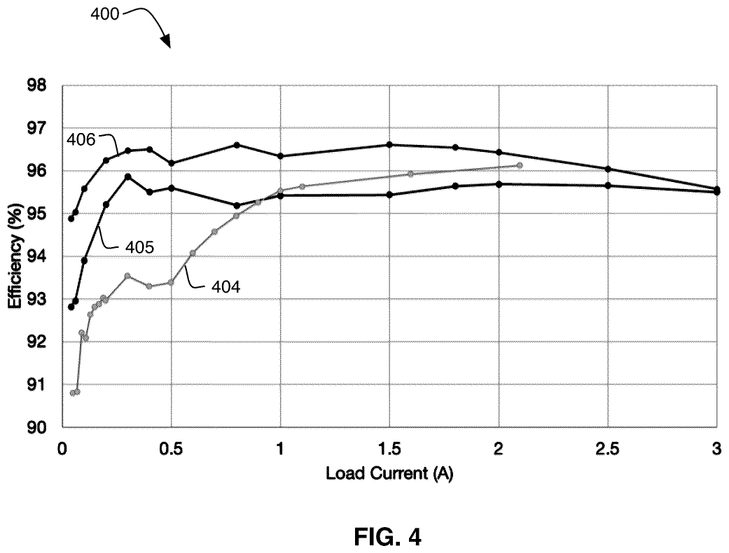

FIG. 4 illustrates a graph 400 of efficiency versus load for sample embodiments of a single-phase buck-boost charger system (curve 404), a dual phase buck-boost charger system with discrete boost switching devices (curve 405), and a dual phase buck-boost charger system with integrated boost switching devices (curve 406). The example current and efficiency values are for particular embodiments of each topology, with other circuit configuration and parameters being equivalent. As can be seen from the illustrated curves, transitioning from a single-phase implementation (curve 404) to a dual phase implementation (curves 405 and 406) can provide substantial efficiency improvements, particularly in lower current regimes. Additionally, the dual phase configuration can allow for higher load currents. Additionally, transitioning from a dual phase configuration with all discrete switching devices (curve 405) to a dual phase configuration with partial integration, e.g., with the boost switching devices integrated with the controller can provide still further efficiency gains with substantially smaller overall size, thus demonstrating potential advantages of a system as described herein.

The foregoing describes exemplary embodiments of a dual phase buck-boost charger architecture with external buck switching devices and internal, on-die boost switching devices. Such configurations may be used in a variety of applications but may be particularly advantageous when used in conjunction with computer power supplies, including but not limited to notebook computers and the like. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A multi-phase buck-boost converter system comprising an external discrete component power stage and a controller integrated circuit, wherein:
the external discrete component power stage includes:
a first phase having an input half bridge including first and second discrete switching devices and a corresponding first discrete inductor operable as a first buck stage; and
a second phase having an input half bridge including third and fourth discrete switching devices and a corresponding second discrete inductor operable as a second buck stage; and
the controller integrated circuit includes:
a first output half bridge corresponding to the first phase and having fifth and sixth integrated switching devices coupled to the first discrete inductor and operable as a first boost stage in conjunction with the first buck stage as a first buck-boost converter;
a second output half bridge corresponding to the second phase and having seventh and eighth integrated switching devices coupled to the second discrete inductor and operable as a second boost stage in conjunction with the second buck stage as a second buck-boost converter; and
controller circuitry that operates the first and second buck-boost converters to produce a regulated output voltage from an input voltage.

2. The multi-phase buck-boost converter system of claim 1 wherein the first and second phases and first and second output half bridges are operable for high load operation, and only one of the first phase and first output half bridge or second phase and second output half bridge is operable for low load operation.

3. The multi-phase buck-boost converter system of claim 1 wherein:
the regulated output voltage is used for battery charging; and
the controller integrated circuit further comprises controller circuitry that controls a charging voltage delivered to a battery.

4. The multi-phase buck-boost converter system of claim 3 wherein the controller integrated circuit includes one or more sensing inputs selected from the group consisting of: an input voltage sensing input, an input current sensing input, an output voltage sensing input, and a battery current sensing input.

5. The multi-phase buck-boost converter system of claim 1 wherein the fifth, sixth, seventh, and eighth switching devices are integrated on a single integrated circuit die with the controller circuitry that operates the first and second buck-boost converters to produce the regulated output voltage from the input voltage.

6. The multi-phase buck-boost converter system of claim 1 wherein the first, second, third, and fourth discrete switching devices are GaN switching devices.

7. The multi-phase buck-boost converter system of claim 1 wherein the controller circuitry that operates the first and second buck-boost converters to produce the regulated output voltage from the input voltage operates the first and second buck-boost converters at the same switching frequency and 180 degrees out of phase.

8. The multi-phase buck-boost converter system of claim 1 wherein the first, second, third, fourth, fifth, sixth, seventh, and eighth switching devices are MOSFET devices.

9. A controller integrated circuit for a multi-phase buck-boost converter system, the controller integrated circuit comprising:
a first output half bridge corresponding to a first phase of the multi-phase buck-boost converter system and having first and second integrated switching devices couplable to a first external inductor and operable as a first boost stage in conjunction with a first external discrete component buck stage as a first buck-boost converter;
a second output half bridge corresponding to a second phase of the multi-phase buck-boost converter system and having third and fourth integrated switching devices couplable to a second external inductor and operable as a second boost stage in conjunction with a second external discrete component buck stage as a second buck-boost converter; and
controller circuitry that operates the first and second buck-boost converters to produce a regulated output voltage from an input voltage.

10. The controller integrated circuit for a multi-phase buck-boost converter system of claim 9 wherein the first and second phases and first and second output half bridges are operable for high load operation, and only one of the first phase and first output half bridge or second phase and second output half bridge is operable for low load operation.

11. The controller integrated circuit for a multi-phase buck-boost converter system of claim 9 wherein:
the regulated output voltage is used for battery charging; and
the controller integrated circuit further comprises controller circuitry that controls a charging voltage delivered to a battery.

12. The controller integrated circuit for a multi-phase buck-boost converter system of claim 11 wherein the controller integrated circuit includes one or more sensing inputs selected from the group consisting of: an input voltage sensing input, an input current sensing input, an output voltage sensing input, and a battery current sensing input.

13. The controller integrated circuit for a multi-phase buck-boost converter system of claim 9 wherein the first, second, third, and fourth switching devices are integrated on a single integrated circuit die with the controller circuitry that operates the first and second buck-boost converters to produce the regulated output voltage from the input voltage.

14. The controller integrated circuit for a multi-phase buck-boost converter system of claim 9 wherein the controller integrated circuit includes a plurality of drive outputs each corresponding to an external discrete switching device of the first or second external buck stages.

15. The controller integrated circuit for a multi-phase buck-boost converter system of claim 9 wherein the controller integrated circuit includes a first and second power inputs respectively couplable to the first and second external inductors that connect the first and second external inductors to respective switch nodes of the first and second output half bridges.

16. The controller integrated circuit for a multi-phase buck-boost converter system of claim 9 wherein the controller circuitry that operates the first and second buck-boost converters to produce the regulated output voltage from the input voltage operates the first and second buck-boost converters at the same switching frequency and 180 degrees out of phase.

17. An electronic device comprising:
one or more electronic systems selected from the group consisting of a processor, a memory, storage, a display, an input device, an I/O interface, and a network interface; and
a power system including a multi-phase buck-boost converter system that includes an external discrete component power stage and a controller integrated circuit, wherein:
the external discrete component power stage includes:
a first phase having an input half bridge including first and second discrete switching devices and a corresponding inductor operable as a first buck stage; and
a second phase having an input half bridge including third and fourth discrete switching devices and a corresponding inductor operable as a second buck stage; and
the controller integrated circuit includes:
a first output half bridge corresponding to the first phase and having fifth and sixth integrated switching devices coupled to the first inductor and operable as a first boost stage in conjunction with the first buck stage as a first buck-boost converter;
a second output half bridge corresponding to the second phase and having seventh and eighth integrated switching devices coupled to the second inductor and operable as a second boost stage in conjunction with the second buck stage as a second buck-boost converter; and
controller circuitry that operates the first and second buck-boost converters to produce a regulated output voltage from an input voltage, wherein the regulated output voltage is used to power the one or more electronic systems.

18. The electronic device of claim 17 wherein the first and second phases and first and second output half bridges are operable for high load operation, and only one of the first phase and first output half bridge or second phase and second output half bridge is operable for low load operation.

19. The electronic device of claim 17 wherein:
the power system includes a battery;
the regulated output voltage is used for battery charging; and
the controller integrated circuit further comprises controller circuitry that controls a charging voltage delivered to a battery.

20. The electronic device of claim 17 wherein the fifth, sixth, seventh, and eighth switching devices are integrated on a single integrated circuit die with the controller circuitry that operates the first and second buck-boost converters to produce the regulated output voltage from the input voltage.

21. The electronic device of claim 17 wherein the first, second, third, and fourth discrete switching devices are GaN switching devices.

22. The electronic device of claim 17 wherein the controller circuitry that operates the first and second buck-boost converters to produce the regulated output voltage from the input voltage operates the first and second buck-boost converters at the same switching frequency and 180 degrees out of phase.

23. The electronic device of claim 17 wherein the first, second, third, fourth, fifth, sixth, seventh, and eighth switching devices are MOSFET devices.
